(19) United States
(12) Patent Application Publication
(10) Pub. No.: US 2017/0326527 A1
(43) Pub. Date: Nov. 16, 2017

(54) CARBON POROUS BODY, PRODUCTION METHOD THEREOF, AMMONIA ADSORBENT MATERIAL, CANISTER, AND PRODUCTION METHOD THEREOF

(71) Applicant: Cataler Corporation, Kakegawa-shi (JP)

(72) Inventors: Tetsuya Kume, Kakegawa-shi (JP); Yuji Mochizuki, Kakegawa-shi (JP); Yasuyuki Higaonna, Kakegawa-shi (JP); Norihiko Setoyama, Nagakute-shi (JP)

(73) Assignee: Cataler Corporation, Kakegawa-shi (JP)

(21) Appl. No.: 15/636,720

(22) Filed: Jun. 29, 2017

Related U.S. Application Data
(63) Continuation of application No. PCT/JP2016/056419, filed on Mar. 2, 2016.

(30) Foreign Application Priority Data
Mar. 5, 2015 (JP) 2015-043718
Feb. 19, 2016 (JP) 2016-030343

(51) Int. Cl. B01J 20/20; B01J 20/28; C01B 32/348; B01D 53/02

(52) U.S. Cl. CPC B01J 20/20; B01D 53/02; B01J 20/28066; C01B 32/348; B01J 20/28071; B01J 20/28064; B01D 2253/308; B01D 2253/306; B01D 2253/102; B01D 2253/311; B01D 2257/102; B01D 2257/708; C01P 2006/12; C01P 2006/14; B01D 2257/406

(57) ABSTRACT

A carbon porous body has a micropore volume, calculated from an αₛ plot analysis of a nitrogen adsorption isotherm at a temperature of 77 K, of 0.1 cm³/g or less, the micropore volume being smaller than a mesopore volume calculated by subtracting the micropore volume from a nitrogen adsorption amount at a nitrogen relative pressure P/P₀ of 0.97 on the nitrogen adsorption isotherm, wherein a nitrogen adsorption amount at a nitrogen relative pressure P/P₀ of 0.5 on the nitrogen adsorption isotherm is within a range of 500 cm³ (STP)/g or less, and a nitrogen adsorption amount at a nitrogen relative pressure P/P₀ of 0.85 on the nitrogen adsorption isotherm is within a range of 600 cm³ (STP)/g or more and 1100 cm³ (STP)/g or less.

### CROSS-REFERENCE TO RELATED APPLICATIONS

This application is a Continuation application of PCT Application No. PCT/JP2016/056419, filed Mar. 2, 2016 and based upon and claiming the benefit of priority from prior Japanese Patent Applications NO. 2015-043718, filed Mar. 5, 2015, and No. 2016-030343, filed Feb. 19, 2016; the entire contents of all of which are incorporated herein by reference.

### FIELD

The present invention relates to a carbon porous body, a production method thereof, an ammonia adsorbent material, a canister, and a production method thereof.

### BACKGROUND

Hitherto, carbon porous bodies have been utilized in various technical fields. Specifically, the carbon porous body is utilized as an electrode material in an electrochemical capacitor, utilized as an electrode catalyst carrier in a solid polymer-type fuel cell, utilized as a material carrying an enzyme in an electrode of a biofuel cell, utilized as an adsorbent in a canister, and utilized as an adsorbent in a fuel purification facility.

The electrochemical capacitor is a capacitor utilizing a capacitance resulting from a non-Faraday reaction with no exchange of electrons between an electrode and ions at an interface between an electrode (positive or negative electrode) and an electrolytic solution or a Faraday reaction with the exchange of electrons. The solid polymer-type fuel cell is a fuel cell using, as an electrolyte, a solid polymer membrane having an ionic conductivity and includes a negative electrode, a positive electrode, and the solid polymer membrane. In the solid polymer-type fuel cell, protons and electrons are generated by decomposing a fuel such as hydrogen or methanol utilizing a catalyst in the negative electrode; the protons and the electrons move to the positive electrode through the solid polymer membrane and an external circuit, respectively; and a reduction reaction of oxygen with the protons and the electrons is promoted by a catalyst in the positive electrode to generate water. Electric energy can be taken out from the solid polymer-type fuel cell by the series of the reactions. As in a usual fuel cell, the biofuel cell contains a negative electrode, a positive electrode, electrolyte and a separator, and utilizes enzymes in the negative electrode and the positive electrode. In the biofuel cell, protons and electrons are generated by decomposing a sugar utilizing the enzyme in the negative electrode; the protons and the electrons move to the positive electrode through the electrolyte and an external circuit, respectively; and a reduction reaction of oxygen with the protons and the electrons is promoted by the enzyme in the positive electrode to generate water. Electric energy can be taken out from the biofuel cell by the series of the reactions. The canister is a can-shaped container filled with carbon porous bodies, and is installed in an automobile. The canister receives a gasoline vapor, generated in a fuel tank, through piping and adsorbs it under suspension of an engine of an automobile, and releases the adsorbed gasoline vapor by passing fresh air therethrough and supplies it to a combustion chamber of the engine during operation of the engine. The fuel purification facility purifies a fuel by causing adsorption of impurities contained in the fuel onto a carbon porous body.

As the carbon porous body, a substance in which a part of a carbon skeleton is substituted by nitrogen atoms is known up to now (Jpn. Pat. Appln. KOKAI Publication No. 2011-051828). The carbon porous body has a micropore structure with an average pore size of 2 nm or less. On the other hand, a low density carbon foam having a cell size of about 0.1 μm is also known (U.S. Pat. No. 4,873,218). The carbon foam is synthesized in such a manner that resorcinol and formaldehyde are subjected to polycondensation to obtain polymer clusters, the polymer clusters are cross-linked with covalent bond to each other to synthesize a gel, the resulting gel is treated under supercritical conditions to obtain an aerogel, and the resulting aerogel is carbonized.

### SUMMARY

Hitherto, a carbon porous body has not been known which has a mesopore structure and greatly changes its nitrogen adsorption amount in response to a change in the nitrogen relative pressure within a range of a comparatively high nitrogen relative pressure. Thus, naturally, a method of easily producing such a carbon porous body has not been known. This carbon porous body can be expected to be utilized as a desorbent for a specific gas, an electrode material of an electrochemical capacitor, a material carrying an enzyme in an electrode of a biofuel cell, an adsorbent of a canister, an adsorbent of a fuel purification facility, and the like.

The present invention has been made to solve the problems described above, and mainly aims at providing a carbon porous body which greatly changes its nitrogen adsorption amount in response to a change in a nitrogen relative pressure within a range of a comparatively high nitrogen relative pressure, while having a mesopore structure.

The present inventors have made intensive studies in order to attain the objective described above, and have found that a carbon porous body has excellent properties which is obtained by heating a calcium salt of terephthalic acid at 550 to 700° C. in an inert atmosphere to form a composite of carbon and calcium carbonate, and washing the composite with an acidic aqueous solution to remove the calcium carbonate; and have completed the present invention.

According to a first aspect of the present invention, there is a provided a carbon porous body which has a micropore volume, calculated from an αₛ plot analysis of a nitrogen adsorption isotherm at a temperature of 77 K, of 0.1 cm³/g or less, the micropore volume being smaller than a mesopore volume calculated by subtracting the micropore volume from a nitrogen adsorption amount at a nitrogen relative pressure P/P₀ of 0.97 on the nitrogen adsorption isotherm, wherein a nitrogen adsorption amount at a nitrogen relative pressure P/P₀ of 0.5 on the nitrogen adsorption isotherm is within a range of 500 cm³ (STP)/g or less, and a nitrogen adsorption amount at a nitrogen relative pressure P/P₀ of 0.85 on the nitrogen adsorption isotherm is within a range of 600 cm³ (STP)/g or more and 1100 cm³ (STP)/g or less.

According to a second aspect of the present invention, there is provided a method of producing a carbon porous body, comprising: heating an alkaline earth metal salt of benzene dicarboxylic acid at 550 to 700° C. in an inert atmosphere in the presence of a trapping material that adsorbs hydrocarbon gas to form a composite of carbon and an alkaline earth metal carbonate; and washing the composite with washing liquid capable of dissolving the carbonate to remove the carbonate, thereby obtaining a carbon porous body.

According to a third aspect of the present invention, there is provided an ammonia adsorbent comprising the carbon porous body according to the first aspect.

According to a fourth aspect of the present invention, there is provided a canister comprising: a container; and a carbon porous body housed in the container, wherein the carbon porous body has a nitrogen adsorption amount at a nitrogen relative pressure P/P₀ of 0.99 on a nitrogen adsorption isotherm at a temperature of 77 K of 1500 cm³ (STP)/g or more.

According to a fifth aspect of the present invention, there is provided a method of producing a canister, comprising: heating an alkaline earth metal salt of benzene dicarboxylic acid at a temperature within a range of 550° C. to 700° C. in an inert atmosphere in the presence of a trapping material that adsorbs hydrocarbon gas to form a composite of carbon and an alkaline earth metal carbonate; and washing the composite with washing liquid capable of dissolving the carbonate to remove the carbonate from the composite, thereby obtaining a carbon porous body.

### BRIEF DESCRIPTION OF THE DRAWINGS

FIG. 1 is a graph showing the Type IV adsorption isotherm in the IUPAC classification;

FIG. 2 is a perspective view schematically showing a canister according to an embodiment of the present invention;

FIG. 3 is a cross-sectional view taken along the line of the canister shown in FIG. 2;

FIG. 4 is a cross-sectional view schematically showing another example of a structure which can be adopted for the canister shown in FIGS. 2 and 3;

FIG. 5 is a cross-sectional view schematically showing still another example of the structure which can be adopted for the canister shown in FIGS. 2 and 3;

FIG. 6 is a graph showing nitrogen adsorption isotherms of Experimental Examples A to C;

FIG. 7 is a graph showing ammonia adsorption isotherms of Experimental Examples A and C; and

FIG. 8 is a graph showing an example of a relationship between a nitrogen adsorption amount at a nitrogen relative pressure P/P₀ is 0.99 on a nitrogen adsorption isotherm measured at a temperature of 77 K and a pentane desorption ratio.

### DETAILED DESCRIPTION

### First Embodiment

A carbon porous body according to a first embodiment has a micropore volume, calculated from an αₛ plot analysis of a nitrogen adsorption isotherm at a temperature of 77 K, of 0.1 cm³/g or less, the micropore volume being smaller than a mesopore volume calculated by subtracting the micropore volume from a nitrogen adsorption amount at a nitrogen relative pressure P/P₀ of 0.97 on the nitrogen adsorption isotherm. A nitrogen adsorption amount (A1) at a nitrogen relative pressure P/P₀ of 0.5 on the nitrogen adsorption isotherm is within a range of 500 cm³ (STP)/g or less, and a nitrogen adsorption amount (A2) at a nitrogen relative pressure P/P₀ of 0.85 on the nitrogen adsorption isotherm is within a range of 600 cm³ (STP)/g or more and 1100 cm³ (STP)/g or less. Here, the mesopore refers to a pore having a diameter of more than 2 nm and 50 nm or less, and the micropore refers to a pore having a diameter of 2 nm or less. The nitrogen adsorption amount A1 may be, for example, 100 cm³ (STP)/g or more, 278 cm³ (STP)/g or more, or 421 cm³ (STP)/g or more. The nitrogen adsorption amount A1 may be 421 cm³ (STP)/g or less, or 278 cm³ (STP)/g or more. The nitrogen adsorption amount A2 may be, for example, 628 cm³ (STP)/g or more, 650 cm³ (STP)/g or more, or 1016 cm³ (STP)/g or more. The nitrogen adsorption amount A2 may be 1016 cm³ (STP)/g or less, or 628 cm³ (STP)/g or less.

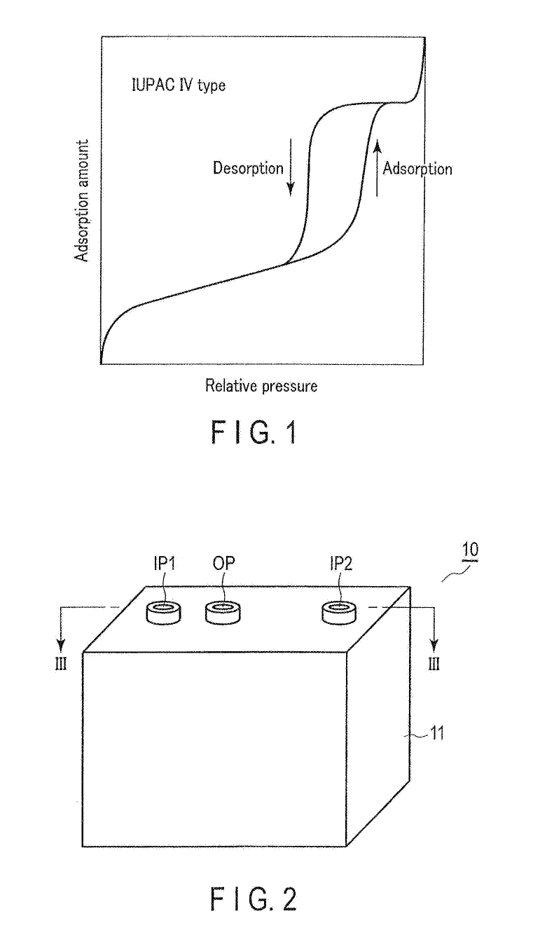

The carbon porous body has preferably a micropore volume of 0.1 cm³ /g or less, more preferably 0.01 cm³ /g or less. In addition, it is preferable that a nitrogen adsorption isotherm at the temperature of 77 K belong to Type IV in IUPAC classification. In such a case, a type of the nitrogen adsorption isotherm in IUPAC classification is Type IV indicating the existence of a mesopore (see FIG. 1), and it can be said that the porous body is mostly formed of mesopores, because a volume of a pore having a diameter of 2 nm or less is as small as 0.1 cm³/g or less.

In addition, in the carbon porous body according to the first embodiment, a value obtained by subtracting a nitrogen adsorption amount at a nitrogen relative pressure P/P₀ of 0.5 on the nitrogen adsorption isotherm from a nitrogen adsorption amount at a nitrogen relative pressure P/P₀ of 0.85 (a difference in the nitrogen adsorption amount (ΔA)) is 100 cm³ (STP)/g or more, and thus a variation of the nitrogen adsorption amount relative to a variation of the nitrogen relative pressure is large in an area having a comparatively large nitrogen relative pressure. As a result, an adsorption/desorption amount of a gas can be increased when a gas pressure of the specific gas is varied within a predetermined range. The difference ΔA in the nitrogen adsorption amount is preferably 200 cm³ (STP)/g or more, more preferably 300 cm³ (STP)/g or more, still more preferably 500 cm³ (STP)/g or more. The difference ΔA in the nitrogen adsorption amount may be, for example, 350 cm³ (STP)/g or more, or 595 cm³ (STP)/g or more. The upper limit of the difference ΔA in the nitrogen adsorption amount is not particularly limited, and it may be 1000 cm³ (STP)/g or less, 595 cm³ (STP)/g or less, or 350 cm³ (STP)/g or less.

In the carbon porous body according to the first embodiment, a nitrogen adsorption amount (A3) at a nitrogen relative pressure P/P₀ of 0.99 is preferably within a range of 1500 cm³ (STP)/g or more on a nitrogen adsorption isotherm at a temperature of 77 K. In such a case, a value obtained by subtracting a nitrogen adsorption amount at a nitrogen relative pressure P/P₀ of 0.5 on the nitrogen adsorption isotherm from a nitrogen adsorption amount at a nitrogen relative pressure P/P₀ of 0.99 is 1000 cm³ (STP)/g or more, and thus the variation of the nitrogen adsorption amount relative to the variation of the nitrogen relative pressure is large in an area having a comparatively large nitrogen relative pressure. As a result, an adsorption/desorption amount of a gas can be increased when a gas pressure of the specific gas is varied within a predetermined range. The nitrogen adsorption amount A3 may be 1517 cm³ (STP)/g or more, or 1948 cm³ (STP)/g or more. The upper limit of the nitrogen adsorption amount A3 is not particularly limited, and it may be, for example, 2000 cm³ (STP)/g or less, 1948 cm³ (STP)/g or less, or 1517 cm³ (STP)/g or less.

The carbon porous body according to the first embodiment may have a BET specific surface area of 700 m²/g or more, or a BET specific surface area of 800 m²/g or more. The carbon porous body according to the first embodiment may also have a BET specific surface area of 1200 m²/g or less. This is because the size of the specific surface area correlates to the improvement of various functional properties.

The carbon porous body according to the first embodiment is particularly suitable for, for example, an electrode material of an electrochemical capacitor. In the electrochemical capacitor, positive or negative ions forming an electric double layer can more smoothly move by using the electrode material having comparatively large mesopores.

A method for producing the carbon porous body according to the first embodiment is a method in which a alkaline earth metal salt of benzene dicarboxylic acid is heated at a range of 550 to 700° C. in the presence of a trapping material adsorbing hydrocarbon gas in an inert atmosphere to form a composite of carbon and an alkaline earth metal carbonate; the composite is washed with washing liquid capable of dissolving the carbonate to remove the carbonate, whereby the carbon porous body is obtained. This method is preferable for obtaining the carbon porous body according to the first embodiment.

The trapping material may be any material as long as it adsorbs (removes by adsorption) hydrocarbon gases, and may be, for example, at least one selected from the group consisting of activated carbon, silica gel, zeolite, and diatom earth. Of these, the activated carbon is preferable. The trapping material may exist in a mixture with the alkaline earth metal salt of benzene dicarboxylic acid, and/or may be formed into a shape of filter and disposed on an upper part of the benzene dicarboxylic acid. The trapping material may exist in another state. As the filter-shaped, trapping material, for example, a honeycomb-formed trapping material, a trapping material coated on a ceramic or metal honeycomb carrier or mesh material, a trapping material put between multiple metal mesh materials and fixed, and the like, can be used. When the alkaline earth metal salt of benzene dicarboxylic acid is heated in the presence of the trapping material, a concentration of a hydrocarbon gas, generated upon the heating, can be comparatively easily controlled to a range preferable for obtaining the carbon porous body according to the first embodiment. An amount of the trapping material is not particularly limited, and, for example, is preferably adjusted to a range of 100% by mass or more and 1000% by mass or less relative to the benzene dicarboxylic acid, more preferably a range of 200% by mass or more and 300% by mass or less.

In the method for producing the carbon porous body according to the first embodiment, benzene dicarboxylic acid may include, for example, phthalic acid (benzene-1,2-dicarboxylic acid), isophthalic acid (benzene-1,3-dicarboxylic acid), and terephthalic acid (benzene-1,4-dicarboxylic acid). Of these, terephthalic acid is preferable. The alkaline earth metal may include magnesium, calcium, strontium, barium, and the like. Of these, calcium is preferable. The alkaline earth metal salt of benzene dicarboxylic acid may be a commercial product purchased or may be synthesized by mixing benzene dicarboxylic acid and an alkaline earth metal hydroxide in water. In such a case, as for a molar ratio of the benzene dicarboxylic acid and the alkaline earth metal hydroxide, a stoichiometric amount based on a neutralization reaction formula may be used, or an excess amount of one reagent, compared to the amount of the other reagent, may be used. For example, the molar ratio may be adjusted to a range of 1.5:1 to 1:1.5. When the benzene dicarboxylic acid and the alkaline earth metal hydroxide are mixed in water, the mixture may be heated at a range of 50 to 100° C.

In the method for producing the carbon porous body according to the first embodiment, the inert atmosphere may include a nitrogen atmosphere, an argon atmosphere, and the like. It is preferable to adjust the heating temperature to 550 to 700° C. When the temperature is lower than 550° C., undesirably, the nitrogen adsorption amount at a nitrogen relative pressure P/P₀ of 0.85 on the nitrogen adsorption isotherm at 77 K is insufficiently increased. When it is higher than 700° C., the carbon porous body cannot be obtained, which is not desirable. It is considered that the composite of the carbon and the alkaline earth metal carbonate obtained after the heating has a structure in which the alkaline earth metal carbonate enters between layers of a layered carbide. A retention time at the heating temperature may be, for example, 50 hours or less. It is preferably 0.5 to 20 hours, more preferably 1 to 10 hours. When the retention time is 0.5 hours or more, the formation of the composite of carbon and an alkaline earth metal carbonate is sufficiently performed. When it is 20 hours or less, a carbon porous body having a comparatively large BET specific surface area can be obtained.

In the method for producing the carbon porous body according to the first embodiment, as the washing liquid capable of dissolving the alkaline earth metal carbonate, it is preferable to use, for example, water or an acidic aqueous solution, when the alkaline earth metal carbonate is calcium carbonate. The acidic aqueous solution may include, for example, an aqueous solution of hydrochloric acid, nitric acid, or acetic acid. It can be considered that when such washing is performed, parts of the composite where the alkaline earth metal carbonate exists turn into cavities.

The ammonia adsorbent according to the first embodiment is consisting of the carbon porous body described above. The ammonia adsorbent preferably has a value, obtained by subtracting an ammonia adsorption amount at an ammonia pressure of 300 kPa from an ammonia adsorption amount at an ammonia pressure of 390 kPa, of 0.40 g/g or more. In this case, a large amount of ammonia can be adsorbed or released by controlling the ammonia pressure. The ammonia adsorbent according to the first embodiment is particularly suitable as, for example, an ammonia adsorbent for an ammonia adsorption tank in a heat storage device using ammonia as a working medium. This is because the heat storage device uses a heat storage material which is reacted with ammonia particularly in a certain pressure range, and thus it is required that ammonia be taken in and out in as large an amount as possible in a pressure range preferable for the reaction of the heat storage material.

The present invention is not limited to the embodiment described above, and needless to say, the present invention can be carried out in various aspects as long as it is within a technical scope of the present invention.

For example, the carbon porous body according to the first embodiment is not limited to the product produced by the method for producing the carbon porous body according to the first embodiment. For example, the carbon porous body according to the first embodiment may be obtained by a method in which the alkaline earth metal salt of benzene dicarboxylic acid is heated at 550 to 700° C. in the inert atmosphere to form a composite of carbon and alkaline earth metal carbonate, the composite is washed with washing liquid capable of dissolving the carbonate to remove the carbonate. That is, the carbon porous body may be obtained in the absence of the trapping material.

The carbon porous body according to the first embodiment can be utilized as, for example, an adsorbent for nitrogen or ammonia, and further as an electrode material for an electrochemical capacitor, an electrode catalyst carrier in a solid polymer-type fuel cell, a material for carrying an enzyme in an electrode in a biofuel cell, an adsorbent in a canister, an adsorbent in a fuel purification facility, and the like.

### Second Embodiment

Almost all automotive vehicles utilizing power generated by a combustion engine as a driving force use a liquid fuel such as gasoline or light oil as its fuel. The liquid fuel contains volatile organic compounds (hereinafter referred to as “VOC”). For that reason, VOC volatilizes in a fuel tank in a downtime during which the combustion engine is stopped. The vaporization of VOC may possibly increase an internal pressure of the fuel tank.

In automobiles having an internal combustion engine, the vaporized VOC is collected in a canister in which an adsorbent is housed in an airtight container. Specifically, the interior of the airtight container is connected to an upper space of the fuel tank during the downtime, and the vaporized VOC is adsorbed with an adsorbent formed of activated carbon. When the activated carbon adsorbs VOC, the adsorption power is decreased according to the adsorption amount thereof. In the automobile on which the canister is mounted, accordingly, air is passed through an adsorbent material layer as a purge gas in an operation period during which an internal combustion engine is operated, thereby desorbing VOC from the activated carbon. Furthermore, gases discharged from the canister through the above operation are burned in the internal combustion engine.

It is required for the canister that the activated carbon adsorbs a sufficient amount of VOC during the downtime, and much of the VOC adsorbed is desorbed from the activated carbon during the operation period. According to a fuel vapor treatment apparatus described in Jpn. Pat. Appln. KOKAI Publication No. 2012-31785, and a canister described in Jpn. Pat. Appln. KOKAI Publication No. 2008-38688, a sufficient VOC adsorption amount and desorption amount can be attained.

However, the present inventors consider that there is room for improvement regarding the VOC desorption performance when an amount of purge gas is small in the canister.

Thus, the second embodiment aims at providing a canister having an excellent VOC desorption performance with a small amount of purge gas.

The second embodiment is described below.

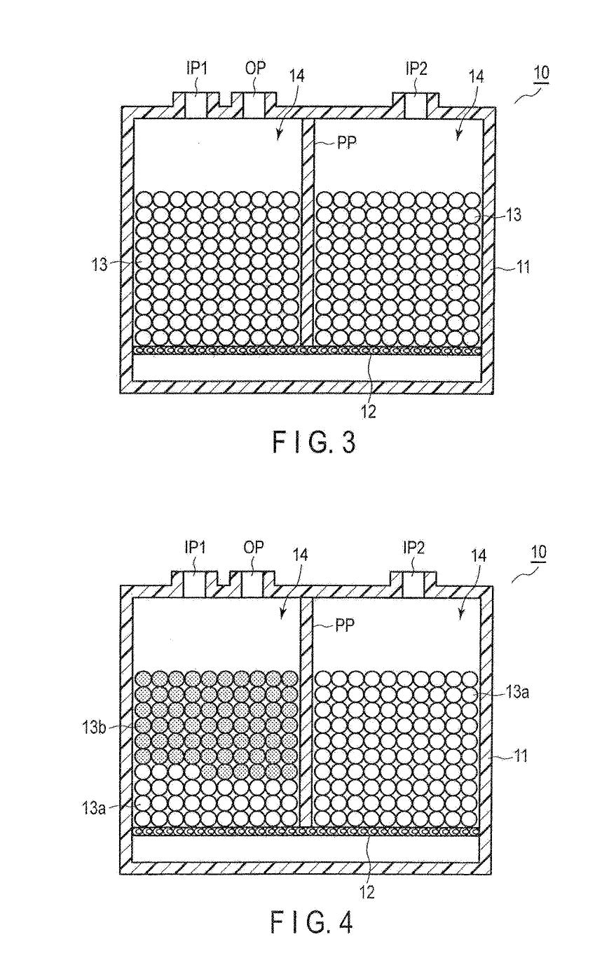

FIG. 2 is a perspective view schematically showing a canister according to one aspect of the present invention. FIG. 3 is a cross-sectional view showing the canister taken along line in FIG. 2.

The canister 10 includes a container 11 with an insulating inner surface. The container 11 is, for example, an airtight container having an inlet port and an outlet port.

Here, as one example, a first inlet port IP1 for supplying gas containing VOC into the container 11, a second inlet port IP2 for supplying purge gas into the container 11, and an outlet port OP for exhausting the purge gas in the container 11 are provided in a top plate part of the container 11. The purge gas is gas having a VOC concentration lower than that of the gas supplied from the first inlet port IP1 into the container 11, such as air.

Also, here, as one example, in the container 11, a partition plate PP extending from the top plate part to a bottom plate part is provided between the second inlet port IP2 and the exhaust port OP. The partition plate PP divides an upper space of the container 11 into a front chamber with which the second inlet port IP2 communicates and a rear chamber with which the first inlet port IP1 and the outlet port OP communicate.

A porous plate 12 formed of an insulator is provided near the bottom part of the container 11. The porous plate 12 is separated from the bottom plate part of the container 11. Typically, the porous plate 12 is provided so that the upper surface thereof is in contact with the partition plate PP. In this way, the communication between the front chamber and the rear chamber can be achieved only through a lower space between the bottom plate part of the container 11 and the porous plate 12. The porous plate 12 is not necessarily provided.

An adsorbent layer 14 containing an adsorbent 13 is provided above the porous plate 12 in the container 11. When the partition plate PP is provided, the thickness of the adsorbent material layer 14 is adjusted to a thickness by which an end part of the partition plate PP on the side of the porous plate 12 is embedded.

The adsorbent 13 contains carbon porous bodies and a binder bonding them.

The carbon porous body has a nitrogen adsorption amount A3 of 1500 cm³ (STP)/g or more, typically 1600 cm³ (STP)/g or more, preferably 1700 cm³ (STP)/g or more, more preferably 1800 cm³ (STP)/g or more. There is no upper limit to the nitrogen adsorption amount A3, but it is, for example, 2500 cm³ (STP)/g or less, typically 2000 cm³ (STP)/g or less. The carbon porous body having a large nitrogen adsorption amount A3 tends to have a higher VOC desorption performance. The term standard temperature and pressure (STP) indicates 0° C. and 10⁵ Pa. Here, the nitrogen adsorption amount A3 means a nitrogen adsorption amount at a nitrogen relative pressure P/P₀ of 0.99 on the nitrogen adsorption isotherm measured at a temperature of 77 K.

The nitrogen adsorption isotherm can be obtained as follows. First, a nitrogen gas adsorption amount (mL/mL) of the carbon porous body is measured for each pressure P while the pressure P (mmHg) of nitrogen gas is gradually increased in a nitrogen gas having a temperature of 77 K (boiling point of nitrogen). Next, a nitrogen gas adsorption amount relative to each relative pressure P/P₀ is plotted, where the relative pressure P/P₀ is a value obtained by dividing the pressure P (mmHg) by a saturated steam pressure P₀ (mmHg) of the nitrogen gas, whereby the adsorption isotherm can be obtained.

FIG. 1 is a graph showing one example of nitrogen adsorption isotherms obtained as above. The nitrogen adsorption isotherm shown in FIG. 1 belongs to Type IV in IUPAC classification. In the nitrogen adsorption isotherm belonging to Type IV in IUPAC classification, the nitrogen adsorption amount when the pressure is increased does not coincide with the nitrogen adsorption amount when the pressure is decreased in a specific relative pressure range. Such a nitrogen adsorption isotherm indicates a possibility that the carbon porous body has pores having a diameter of more than 2 nm and 50 nm or less, i.e., mesopores.

The nitrogen adsorption amount A4 of the carbon porous body is, for example, within a range of 800 cm³ (STP)/g to 1500 cm³ (STP)/g, preferably within a range of 1000 cm³ (STP)/g to 1300 cm³ (STP)/g, more preferably within a range of 1100 cm³ (STP)/g to 1300 cm³ (STP)/g. The carbon porous body having the nitrogen adsorption amount A4 within the ranges described above tends to have a VOC desorption performance higher than that of other carbon porous bodies. Here, the nitrogen adsorption amount A4 means a nitrogen adsorption amount at a nitrogen relative pressure P/P₀ of 0.9 on the nitrogen adsorption isotherm measured at a temperature of 77 K.

The nitrogen adsorption amount A2 of the carbon porous body is, for example, within a range of 600 cm³ (STP)/g to 1100 cm³ (STP)/g, typically within a range of 800 cm³ (STP)/g to 1100 cm³ (STP)/g, preferably within a range of 900 cm³ (STP)/g to 1000 cm³ (STP)/g. The carbon porous body having the nitrogen adsorption amount A2 within the ranges described above tends to have a VOC desorption performance higher than that of other carbon porous bodies. Here, the nitrogen adsorption amount A2 means a nitrogen adsorption amount at a nitrogen relative pressure P/P₀ of 0.85 on the nitrogen adsorption isotherm measured at a temperature of 77 K.

The nitrogen adsorption amount A1 of the carbon porous body is, for example, 500 cm³ (STP)/g or less, typically 400 cm³ (STP)/g or less. There is no lower limit to the nitrogen adsorption amount A1, but it is for example, 50 cm³ (STP)/g or more, typically 100 cm³. (STP)/g or more. The carbon porous body having a small nitrogen adsorption amount A1 tends to have a VOC desorption performance higher than that of other carbon porous bodies. Here, the nitrogen adsorption amount A1 means a nitrogen adsorption amount at a nitrogen relative pressure P/P₀ of 0.5 on the nitrogen adsorption isotherm measured at a temperature of 77 K. The micropore volume of the carbon porous body is, for example, 0.1 cm³/g or less, typically 0.01 cm³/g or less. There is no lower limit to the micropore volume, but it is, for example, 0.001 cm³/g or more, typically 0.005 cm³/g or more. Here, the micropore volume means a volume of a pore having a diameter of 2 nm or less. The carbon porous body having a small micropore volume tends to have a VOC desorption performance higher than that of other carbon porous bodies.

The micropore volume can be obtained by performing an αₛ plot analysis of the nitrogen adsorption isotherm measured at a temperature of 77 K. In the αₛ plot analysis, as the standard isotherm for comparison, a standard isotherm described in “Characterization of porous carbons with high resolution alpha(s)-analysis and low temperature magnetic susceptibility” Kaneko, K; Ishii, C; Kanoh, H; Hanazawa, Y; Setoyama, N; Suzuki, T ADVANCES IN COLLOID AND INTERFACE SCIENCE vol. 76, pp. 295-320 (1998) is used.

The difference ΔA3−A4 in the nitrogen adsorption amount of the carbon porous body is, for example, 300 cm³ (STP)/g or more, typically 400 cm³ (STP)/g or more, preferably 500 cm³ (STP)/g or more. There is no upper limit to the difference ΔA3−A4 in the nitrogen adsorption amount, but it is, for example, 1300 cm³ (STP)/g or less, typically 1000 cm³ (STP)/g or less. The carbon porous body having a large difference ΔA3−A4 in the nitrogen adsorption amount tends to have a VOC desorption performance higher than that of other carbon porous bodies. Here, the difference ΔA3−A4 in the nitrogen adsorption amount means a value obtained by subtracting a nitrogen adsorption amount A4 at a nitrogen relative pressure P/P₀ of 0.9 from a nitrogen adsorption amount A3 at a nitrogen relative pressure P/P₀ of 0.99 in the nitrogen adsorption isotherm measured at a temperature of 77 K.

The difference ΔA3−A2 in the nitrogen adsorption amount of the carbon porous body is, for example, 500 cm³ (STP)/g or more, typically 700 cm³ (STP)/g or more. There is not upper limit in the difference ΔA3−A2 in the nitrogen adsorption amount, but it is, for example, 1300 cm³ (STP)/g or less, typically 1000 cm³ (STP)/g or less. The carbon porous body having a large difference ΔA3−A2 in the nitrogen adsorption amount tends to have a VOC desorption performance higher than that of other carbon porous bodies. Here, the difference ΔA3−A2 in the nitrogen adsorption amount means a value obtained by subtracting a nitrogen adsorption amount A2 at a nitrogen relative pressure P/P₀ of 0.85 from a nitrogen adsorption amount A3 at a nitrogen relative pressure P/P₀ of 0.99 in the nitrogen adsorption isotherm measured at a temperature of 77 K.

The difference ΔA3−A1 in the nitrogen adsorption amount of the carbon porous body is, for example, 1000 cm³ (STP)/g or more, typically 1200 cm³ (STP)/g or more, preferably 1400 cm³ (STP)/g or more. There is no upper limit to the difference ΔA3−A1 in the nitrogen adsorption amount, but it is, for example, 1800 cm³ (STP)/g or less, typically 1500 cm³ (STP)/g or less. The carbon porous body having a large difference ΔA3−A1 in the nitrogen adsorption amount tends to have a VOC desorption performance higher than that of other carbon porous bodies. Here, the difference ΔA3−A1 in the nitrogen adsorption amount means a value obtained by subtracting a nitrogen adsorption amount A1 at a nitrogen relative pressure P/P₀ of 0.5 from a nitrogen adsorption amount A3 at a nitrogen relative pressure P/P₀ of 0.99 in the nitrogen adsorption isotherm measured at a temperature of 77 K.

The difference ΔA4−A2 in the nitrogen adsorption amount of the carbon porous body is, for example, 150 cm³ (STP)/g or more, typically 200 cm³ (STP)/g or more, preferably 250 cm³ (STP)/g or more. There is no upper limit to the difference ΔA4−A2 in the nitrogen adsorption amount, but it is, for example, 400 cm³ (STP)/g or less, typically 300 cm³ (STP)/g or less. The carbon porous body having large difference ΔA4−A2 in the nitrogen adsorption amount tends to have a VOC desorption performance higher than that of other carbon porous bodies. Here, the difference ΔA4−A2 in the nitrogen adsorption amount means a value obtained by subtracting a nitrogen adsorption amount A2 at a nitrogen relative pressure P/P₀ of 0.85 from a nitrogen adsorption amount A4 at a nitrogen relative pressure P/P₀ of 0.9 in the nitrogen adsorption isotherm measured at a temperature of 77 K.

The difference ΔA4−A1 in the nitrogen adsorption amount of the carbon porous body is, for example, 500 cm³ (STP)/g or more, typically 700 cm³ (STP)/g or more, preferably 800 cm³ (STP)/g or more. There is no upper limit to the difference ΔA4−A1 in the nitrogen adsorption amount, but it is, for example, 1200 cm³ (STP)/g or less, typically 1000 cm³ (STP)/g or less. The carbon porous body having a large difference ΔA4−A1 in the nitrogen adsorption amount tends to have a VOC desorption performance higher than that of other carbon porous bodies. Here, the difference ΔA4−A1 in the nitrogen adsorption amount means a value obtained by subtracting a nitrogen adsorption amount A1 at a nitrogen relative pressure P/P₀ of 0.5 from a nitrogen adsorption amount A4 at a nitrogen relative pressure P/P₀ of 0.9 in the nitrogen adsorption isotherm measured at a temperature of 77 K.

The difference ΔA in the nitrogen adsorption amount of the carbon porous body is, for example, 100 cm³ (STP)/g or more, typically 300 cm³ (STP)/g or more, preferably 500 cm³ (STP)/g or more, more preferably 600 cm³ (STP)/g or more. There is no upper limit to the difference ΔA in the nitrogen adsorption amount, but it is, for example, 1200 cm³ (STP)/g or less, typically 1000 cm³ (STP)/g or less. The carbon porous body having a large difference ΔA in the nitrogen adsorption amount tends to have a VOC desorption performance higher than that of other carbon porous bodies. Here, the difference ΔA in the nitrogen adsorption amount means a value obtained by subtracting a nitrogen adsorption amount A1 at a nitrogen relative pressure P/P₀ of 0.5 from a nitrogen adsorption amount A2 at a nitrogen relative pressure P/P₀ of 0.85 in the nitrogen adsorption isotherm measured at a temperature of 77 K.

The specific surface area of the carbon porous body is, for example, 700 m²/g or more, typically 800 m²/g or more. Here, the term “specific surface area” means a specific surface area obtained utilizing a BET adsorption isotherm equation (Brunauer, Emmet and Teller's equation), i.e., a BET specific surface area. There is no upper limit to the specific surface area, but it is, for example 1400 m²/g or less, typically 1200 m²/g or less, preferably 1100 m²/g or less.

The carbon porous body described above can be produced, for example, by the following method.

First, benzene dicarboxylic acid is mixed with a hydroxide of an alkaline earth metal, and the mixture is heated at a temperature of 50° C. to 100° C. in a water bath to produce an alkaline earth metal salt of the benzene dicarboxylic acid. Then, filtration is performed to separate the product salt, which is dried at room temperature.

The benzene dicarboxylic acid is, for example, phthalic acid (benzene-1,2-dicarboxylic acid), isophthalic acid (benzene-1,3-dicarboxylic acid), terephthalic acid (benzene-1,4-dicarboxylic acid), or mixtures thereof, preferably terephthalic acid.

The alkaline earth metal is, for example, magnesium, calcium, strontium, barium, or mixtures thereof, preferably calcium.

A molar ratio of the benzene dicarboxylic acid to the hydroxide of the alkaline earth metal may be a stoichiometric ratio based on a neutralization reaction formula, or may deviate from the stoichiometric ratio. The molar ratio is, for example, within a range of 1.5:1 to 1:1.5.

The alkaline earth metal salt of the benzene dicarboxylic acid may be obtained by the method described above, but a commercial product may be used.

Then the product salt is heated at a temperature of 550° C. to 700° C. in the presence of a trapping material in an inert atmosphere to form a composite of carbon and an alkaline earth metal carbonate. It can be considered that the resulting composite has a structure in which alkaline earth metal carbonate enters between the layers of the layered carbide. As described later, the carbon porous body described above can be obtained by removing the alkaline earth metal carbonate form the composite.

The trapping material adsorbs (adsorbs and removes) hydrocarbon gas. When the alkaline earth metal salt of the benzene dicarboxylic acid is heated in the presence of the trapping material, a concentration of hydrocarbon gas, generated when the alkaline earth metal salt of the benzene dicarboxylic acid is heated, can be easily adjusted to a preferable range at which the above-mentioned pore part of the carbon porous body is attained. The trapping material is, for example, at least one selected from the group consisting of activated carbon, silica gel, zeolite, and diatom earth, preferably activated carbon.

The trapping material may be mixed with the alkaline earth metal salt of the benzene dicarboxylic acid. The trapping material may also be formed into a filter shape, and may be disposed above the alkaline earth metal salt of the benzene dicarboxylic acid. Alternatively, a part of the trapping material may be mixed with the alkaline earth metal salt of the benzene dicarboxylic acid, and the remaining trapping material may be formed into a filter shape and may be disposed above the alkaline earth metal salt of the benzene dicarboxylic acid. The filter-shaped trapping material may include, for example, a honeycomb-shaped trapping material, a trapping material carried on a ceramic or metal honeycomb carrier, and a trapping material put between multiple metal mesh materials and fixed.

The trapping material is used in an amount within a range of preferably 100 parts by mass or more and 1000 parts by mass or less, based on 100 parts by mass of the benzene dicarboxylic acid, more preferably 200 parts by mass or more and 300 parts by mass or less.

The heating temperature is preferably adjusted to a range of 550° C. to 700° C. When the heating temperature is too low, in the obtained carbon porous body, the nitrogen adsorption amount A3 at a nitrogen relative pressure P/P₀ of 0.99 on the nitrogen adsorption isotherm at 77 K tends to be insufficiently large. When the heating temperature is too high, the carbon porous body tends not to be formed. The heating time is adjusted to, for example, 50 hours or less, preferably 0.5 to 20 hours, more preferably 1 to 10 hours. When the heating time is too short, the composite of carbon and an alkaline earth metal carbonate tends to be insufficiently formed. When the heating time is too long, the carbon porous body having a comparatively large BET specific surface area tends not to be obtained. The inert atmosphere may include, for example, a nitrogen atmosphere, and an argon atmosphere.

Next, the resulting composite is washed with washing liquid capable of dissolving the carbonate to remove the carbonate from the composite, whereby the carbon porous body is obtained. It can be considered that when such washing is performed, parts in which the alkaline earth metal carbonate exists in the composite turn into cavities.

When the alkaline earth metal carbonate is calcium carbonate, it is preferable to use water or an acidic aqueous solution such as hydrochloric acid as the washing liquid capable of dissolving the alkaline earth metal carbonate.

Here, the adsorbent 13 may contain two or more kinds of the carbon porous bodies which are produced in different production methods. When the adsorbent 13 contains two or more kinds of the carbon porous bodies which are produced in different production methods, the nitrogen adsorption isotherm of the carbon porous bodies contained in the adsorbent 13 is a nitrogen adsorption isotherm of the mixture of the two or more kinds of the carbon porous bodies produced in different production methods, the isotherm being obtained in the method described above. The nitrogen adsorption isotherm of the carbon porous bodies contained in the adsorbent 13 can also be obtained by weighing and averaging nitrogen adsorption isotherms of the carbon porous bodies, obtained in the method described above, according to the mass ratios of the carbon porous bodies.

A ratio of the carbon porous body to the whole weight of the adsorbent 13 is, for example, within a range of 60% by mass to 90% by mass, typically within a range of 70% by mass to 80% by mass.

The binder may include, for example, cellulose materials, styrene-butadiene rubber resins, urethane resins, and mixtures thereof.

The adsorbent 13 is in the state of, for example, particles, pellets or a honeycomb. The adsorbent 13 has an average particle size of, for example, within a range of 0.1 mm to 10 mm. The average particle size can be obtained in accordance with a calculation method for average particle size provided in Japanese Industrial Standards JIS K 1474: 2014 (7.5). The adsorbent 13 may be in the state of powder. In this case, the adsorbent 13 may be typically carried on a substrate such as a honeycomb substrate or a porous substrate.

The adsorbent layer 14 may contain two or more kinds of the adsorbent 13. FIG. 4 is a cross-sectional view schematically showing another example of a structure which can be adopted for the canister shown in FIGS. 2 and 3. FIG. 5 is a cross-sectional view schematically showing still another example of a structure which can be adopted for the canister shown in FIGS. 2 and 3. In FIGS. 4 and 5, an adsorbent layer 14 contains a first adsorbent 13a and a second adsorbent 13b.

The first adsorbent material 13a contains, for example, a carbon porous body, obtained by the production method described above, and a binder. As the binder, for example, the same binder as listed in the adsorbent 13 can be used.

The second adsorbent 13b contains, for example, a carbon porous body, obtained by a production method different from that for the carbon porous body forming the first adsorbent 13a, and the binder. Such a carbon porous body may include, for example, BAX-1500 (manufactured by MeadWestvaco Corp.). BAX-1500 is activated carbon which does not satisfy the conditions described above. As the binder, for example, the same binder as listed in the adsorbent 13 can be used.

An assembly containing the carbon porous body contained in the first adsorbent 13a and the carbon porous body contained in the second adsorbent 13b satisfies the conditions described above in all. If the assembly satisfies the conditions described above, only one of the first adsorbent 13a and the second adsorbent 13b may satisfy the conditions described above, or both of them may satisfy the conditions.

As shown in FIG. 5, the first adsorbent 13a and the second adsorbent 13b may be mixed. Alternatively, an area of the first adsorbent 13a and an area of the second adsorbent 13b may be disposed in series along a purge gas path. In this case, as shown in FIG. 4, the area of the second adsorbent 13b may be disposed in either one of a front chamber and a rear chamber, or both.

The canister 10 using the carbon porous body satisfying the conditions described above as the adsorbent has an excellent VOC desorption performance even if the purge gas amount is small. The canister 10, accordingly, can further decrease the amount of the adsorbent 13 used, compared to a canister using a carbon porous body which does not satisfy the conditions described above as the adsorbent. Thus, when the carbon porous body is used for the adsorbent in the canister 10, the size of the canister 10 can be reduced, and the weight of the automotive vehicle on which the canister 10 is mounted can be reduced.

The canister 10 described above may be variously modified.

For example, the canister 10 may contain an electrothermal heater, not shown. The electrothermal heater may be installed while being in contact with an adsorbent layer 14, or may be embedded in the adsorbent layer 14. Alternatively, the electrothermal heater may be located on the outer periphery of the container 11. It is possible to prevent a reduced temperature of the adsorbent layer 14, associated with the desorption of VOC from the adsorbent 13, by applying electricity to a resistance heating element in the electrothermal heater when purge gas is supplied into the container 11 through a second inlet port IP2.

The canister 10 may contain a pair of electrodes, not shown, instead of the electrothermal heater. The pair of electrodes may be disposed on an inner wall of the container 11, or may be disposed on a main surface of the partition plate PP and inner walls of the container 11 facing the partition plate. Each of the pair of electrodes is connected to a terminal located outside the container 11. Each electrode contains a metal layer such as a metal plate or a metal foil. Such a canister 10 can utilize the adsorbent layer 14 as a resistance heating element.

Alternatively, the canister 10 may contain a heat storage material, not shown. As a material for the heat storage material, for example, a metal material such as iron or copper, an inorganic material such as ceramic or glass, or a liquid material such as hexadecane may be used. The heat storage material may be brought into contact with the adsorbent layer 14, or may be embedded in the adsorbent layer 14. When the heat storage material is the liquid material, the heat storage material is housed in a heat storage material container, and the heat storage material container may be disposed so as to be brought into contact with the adsorbent layer 14, or may be embedded in the adsorbent layer 14. As a material for the heat storage material container, for example, a material having a thermal conductivity higher than that of the adsorbent 13 can be used. Alternatively, the wall of the container 11 is made into a double structure and the heat storage material may be housed between an outer wall and an inner wall.

When the adsorbent 13 adsorbs VOC, heat transfers from the adsorbent 13 to the heat storage material. When the adsorbent 13 desorbs VOC, the heat transfers from the heat storage material to the adsorbent material 13. The heat storage material, accordingly, can suppress the change in the temperature of the adsorbent material 13.

Alternatively, the canister 10 may include both of the electrothermal heater or the electrode and the heat storage material.

### EXAMPLES

### Examples According to First Embodiment

Examples in which the carbon porous body according to the first embodiment is specifically produced are described below. Experimental Examples A and B correspond to Examples according to the first embodiment, and Experimental Example C corresponds to Comparative Example.

### Experimental Example A

### (Synthesis of Calcium Salt of Terephthalic Acid)

Terephthalic acid (1 mol) and calcium hydroxide (1 mol) were added to 2 L of water, and the mixture was heated at 80° C. for 4 hours in a water bath. A produced calcium salt of terephthalic acid was filtered to isolate crystals, and they were air-dried at room temperature. (Carbonization of Calcium Salt of Terephthalic Acid)

The calcium salt of terephthalic acid (20 g) was put in a tubular electric furnace, on which activated carbon particles (GA-5 manufactured by CATALER Corporation, 20 g) were put as a trapping material, and the inside of the tubular furnace was flow-substituted with an inert gas (a flow rate of 0.1 L/minute). As the inert gas, nitrogen gas was used, but argon gas may also be used. While the gas flow was maintained, the temperature in the tubular furnace was elevated to a preset temperature over one hour. Here, the preset temperature was adjusted to 550° C. After the temperature rising was finished, the preset temperature was maintained for 2 hours and then the temperature was decreased to room temperature, while the gas flow was maintained. In this way, a composite of carbon and calcium carbonate was produced in the tubular furnace.

### (Acid Treatment of Composite)

The composite was taken out from the tubular furnace, and was dispersed in 500 mL of water. To the dispersion was added 2 mol/L of hydrochloric acid and the mixture was stirred until the pH of the liquid reached 4 or less, whereby foaming, caused by the decomposition of the calcium carbonate, was observed. After the filtration of the dispersion, the resulting product was dried and activated carbon particles were subjected to sieving and removal, whereby a carbon porous body of Experimental Example A was obtained (yield: about 4 g).

### Experimental Example B

A carbon porous body of Experimental Example B was obtained (yield: about 5 g) in the same manner as in

Experimental Example A except that the weight of the trapping material was changed to 5 g upon the carbonization of the calcium salt of terephthalic acid.

### Experimental Example C

As a carbon porous body of Experimental Example C, commercially available activated carbon, Mesocoal™ (manufactured by CATALER Corporation) was prepared.

### [Measurement of Properties]

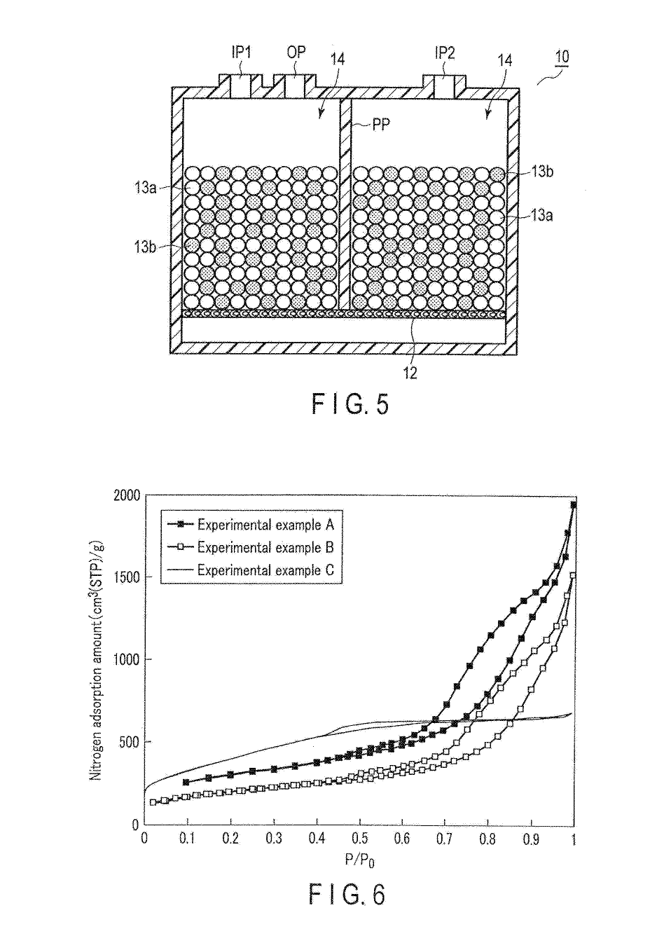

Properties of a carbon porous body of each of Experimental Examples A to C shown in Table 1 were obtained from a nitrogen adsorption measurement at a liquid nitrogen temperature (77 K). FIG. 6 shows nitrogen adsorption isotherms of Experimental Examples A to C at 77 K. In Table 1, a BET specific surface area was calculated from a BET analysis. The nitrogen adsorption isotherm was obtained by performing the measurement using Autosorb-1 manufactured by Quantachrome Corporation and an adsorption amount was analyzed. In the αₛ plot analysis, the micropore volume (cm³ (STP)/g) was obtained from a value of a segment of a plot extrapolation straight line. In the micropore volume (cm³/g) was obtained by the standard gas volume (cm³ (STP)/g) converted with a liquid nitrogen density at 77 K (0.808 g/cm³). A value obtained by subtracting the micropore volume from the nitrogen adsorption amount at a nitrogen relative pressure P/P₀ of 0.97 on the nitrogen adsorption isotherm was calculated as the mesopore volume. Nitrogen adsorption amounts A1 and A2 at nitrogen relative pressures P/P₀ of 0.50 and 0.85 respectively were read from the graph of the nitrogen adsorption isotherm, and the difference between them was defined as the difference ΔA (=A2−A1) in the nitrogen adsorption amount. A nitrogen adsorption amount A3 at a nitrogen relative pressure P/P₀ of 0.99 was read from the graph of the nitrogen adsorption isotherm. In the αₛ plot analysis, as a standard isotherm for comparison, the standard isotherm described in “Characterization of porous carbons with high resolution alpha(s)—analysis and low temperature magnetic susceptibility” Kaneko, K; Ishii, C; Kanoh, H; Hanazawa, Y; Setoyama, N; Suzuki, T ADVANCES IN COLLOID AND INTERFACE SCIENCE vol. 76, pp. 295-320 (1998) was used.

TABLE 1

| | | | | | | | | | Difference in | |
|---|---|---|---|---|---|---|---|---|---|---|
| | | | | | | | | | nitrogen | Difference |
| | | | BET | | | | | | adsorption | in NH₃ |
| | | | specific | | | Nitrogen adsorption amount | | | amount | adsorption |
| | | Carbonization | surface | Pore volume | | A 1 | A 2 | A 3 | Δ A | amount^{2} |
| | Molar | temperature | area | Micropore | Mesopore | (P/P₀ = 0.50) | (P/P₀ = 0.85) | (P/P₀ = 0.99) | (A2-A1) | Δ B |
| | ratio^{1} | (° C.) | (m²/g) | (cm³/g) | (cm³/g) | (cm³(STP)/g) | (cm³(STP)/g) | (cm³(STP)/g) | (cm³(STP)/g) | (g/g) |
| Experimental | 1:1 | 550 | 1019 | <0.01 | 2.50 | 421 | 1016 | 1948 | 595 | 0.78 |
| Example A | | | | | | | | | | |
| Experimental | 1:1 | 550 | 700 | <0.01 | 1.91 | 278 | 628 | 1517 | 350 | 0.46 |
| Example B | | | | | | | | | | |

| | | | | | | | | | |
|---|---|---|---|---|---|---|---|---|---|
| Experimental | Mesocoal was | 1472 | 0.89 | 0.17 | 575 | 641 | 682 | 66 | 0.06 |
| Example C | used^{3.} | | | | | | | | |

^{1}A molar ratio is the number of moles of terephthalic acid:the number of moles of calcium hydroxide.
^{2}Difference in NH₃ adsorption amount Δ B is a value obtained by subtracting a NH₃ adsorption amount at a NH₃ pressure of 300 kPa from a NH₃ adsorption amount at a NH₃ pressure of 390 kPa.
^{3}Mesocoal is conventional activated carbon and is a trademark of CATALER Corporation.

As apparent from Table 1, the carbon porous bodies of Experimental Examples A and B had BET specific surface areas as large as 700 m²/g or more, and micropore volume as small as 0.01 cm³/g or less. The nitrogen adsorption isotherms of the carbon porous bodies of Experimental Examples A and B, shown in FIG. 6, belonged to Type IV in IUPAC classification (the type indicating the existence of mesopores, see FIG. 1). From the above, it can be said that the carbon porous bodies of Experimental Examples A and B are mostly formed of the mesopores.

In the carbon porous bodies of Experimental Examples A and B, the nitrogen adsorption amount A2 at a nitrogen relative pressure P/P₀ of 0.85 was within a range of 600 cm³ (STP)/g or more and 1100 cm³ (STP)/g or less, the nitrogen adsorption amount A1 at a nitrogen relative pressure P/P₀ of 0.5, was within a range of 500 cm³ (STP)/g or less, and the difference in the nitrogen adsorption amount, ΔA, was 100 cm³ (STP)/g or more, on the nitrogen adsorption isotherm. From the above, it can be said that, in the carbon porous bodies of Experimental Examples A and B, the variation in the nitrogen adsorption amount is larger than the variation of the nitrogen relative pressure in the area having a comparatively large nitrogen relative pressure. For that reason, in the carbon porous bodies of Experimental Examples A and B, when the gas pressure of a specific gas (for example, nitrogen) is changed in a given range, the adsorption/desorption amount of the gas can be increased.

On the contrary, the carbon porous body of Experimental Example C had a small difference in the nitrogen adsorption amount, ΔA2, of 66 cm³ (STP)/g. Even if the gas pressure of a specific gas is changed within a given range in Experimental Example C, accordingly, the adsorption/desorption amount of the gas cannot be increased as in Experimental Examples A and B.

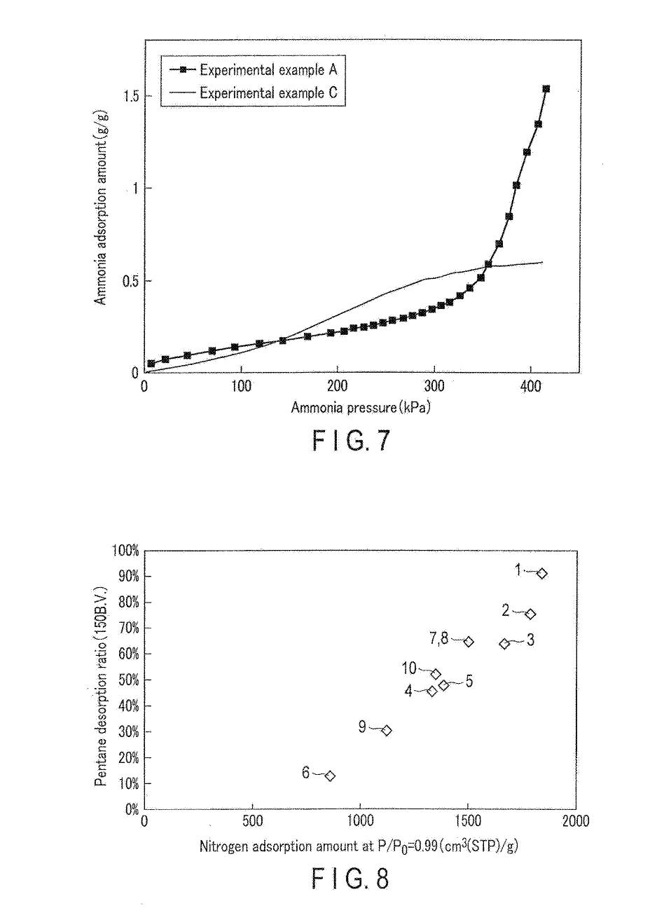

Here, an adsorption measurement of each carbon porous body was performed at 273 K using ammonia as the specific gas. The saturated steam pressure was 430 kPa. The difference in the ammonia adsorption amount, AB, was obtained by subtracting an ammonia adsorption amount B1 at an ammonia pressure of 300 kPa from an ammonia adsorption amount B2 at an ammonia pressure of 390 kPa. The resulting values are shown in Table 1. FIG. 7 shows ammonia adsorption isotherms in Experimental Examples A and C.

As shown in Table 1, the large differences in the ammonia adsorption amount, AB, of 0.78 g/g and 0.46 g/g or more could be obtained in Experimental Example A and Experimental Example B, respectively, at the ammonia pressure within a range of 300 to 390 kPa; whereas only a small value of 0.06 g/g or less could be obtained in Experimental Example C. From the above, it was found that when the carbon porous bodies of Experimental Examples A and B are used, a large amount of ammonia can be adsorbed and released by controlling the ammonia pressure.

### Examples According to Second Embodiments

Examples according to the second embodiment are described below.

### Experimental Example 1

### (Production of Carbon Porous Body PC1)

First, terephthalic acid and calcium hydroxide were weighed in a molar ratio of 1:1, and they were charged into a reactor together with water. Then, the mixture was reacted in a water bath heated to 80° C. to produce a calcium salt of terephthalic acid. Then, the product salt was separated by the filtration. Then, the separated product salt and coconut shell activated carbon having the same amount as that of the product salt were mixed, and the mixture was heat-treated at a temperature of 590° C. in an inert atmosphere to obtain a composite of a carbide and calcium carbonate. Then, the mixture of the composite and the coconut shell activated carbon was dispersed in water, and hydrochloric acid was added dropwise to the dispersion to decompose the calcium carbonate. Then, the dispersion was filtered to separate the carbide and the coconut shell activated carbon therefrom, and the resulting mixture was dried. Then, the mixture was subjected to sieving to remove the coconut shell activated carbon, thereby obtaining the carbide. The coconut shell activated carbon had a size sufficient for filtration from the carbide. The carbide is hereinafter referred to as the “carbon porous body PC1.”

### (Production of Adsorbent Material AM1)

A mixture containing 100 parts by mass of the carbon porous body PC1, 30 parts by mass of a binder, and water was thoroughly kneaded. Then, the mixture was formed into pellets by an extrusion molding method. The pellet had a circular shape with a diameter of 3±1 mm and a height of 9±3 mm. Then, these pellets were thoroughly dried. The pellets are hereinafter referred to as the adsorbent material AM1.

### (Production of Canister C1)

First, the resin container 11, explained referring to FIGS. 2 and 3, was prepared. In the container, a volume of a front chamber was the same as that of a rear chamber. Then, the adsorbent material AM1 was put in the equal amount to each of the front chamber and the rear chamber of the container, and a canister C1 was produced.

### Experimental Example 2

A carbon porous body PC2, an adsorbent material AM2 and a canister C2 were obtained in the same manner as in Experimental Example 1 except that 100 parts by mass of the product salt was heat-treated in the presence of 25 parts by mass of the coconut shell activated carbon, instead of the heat-treatment in the presence of the coconut shell activated carbon having the equal amount to that of the product salt.

### Experimental Example 3

A carbon porous body PC3, an adsorbent material AM3 and a canister C3 were obtained in the same manner as in Experimental Example 1 except that the temperature of the heat-treatment of 590° C. was changed to 550° C.

### Experimental Example 4

A carbon porous body PC4, an adsorbent material AM4 and a canister C4 were obtained in the same manner as in Experimental Example 1 except that the coconut shell activated carbon was not used in the heat-treatment.

### Experimental Example 5

A carbon porous body PC5, an adsorbent material AM5 and a canister C5 were obtained in the same manner as in Experimental Example 1 except that, in the heat-treatment, the coconut shell activated carbon was not used and the temperature of the heat treatment of 590° C. was changed to 550° C.

### Experimental Example 6

A canister C6 was obtained in the same manner as in Experimental Example 1 except that BAX-1500 (manufactured by MeadWestvaco Corp.) was used as an adsorbent material AM6, instead of the adsorbent material AM1.

### Experimental Example 7

A canister C7 was obtained in the same manner as in Experimental Example 1 except that a part of the adsorbent material AM1 was substituted by the adsorbent material AM6 as shown in FIG. 4.

Specifically, first, the adsorbent material AM1 was put into the front chamber in the same amount as in Experimental Example 1. Then, the adsorbent material AM1 was put into the rear chamber, and the adsorbent material AM6 was put on the area formed of the adsorbent material AM1. A mass ratio of the adsorbent material AM1 to the adsorbent material AM6, which were put into the rear chamber, was 16:34. The total amount of the adsorbent materials was the same as that of the adsorbent material AM1 put into the front chamber.

### Experimental Example 8

First, 66 parts by mass of the adsorbent material AM1 and 34 parts by mass of the adsorbent material AM6 were uniformly mixed to obtain a mixture. Then, a canister C8 was obtained in the same manner as in Experimental Example 1 except that the mixture obtained above was put instead of the adsorbent material AM1.

### Experimental Example 9

A canister C9 was obtained in the same manner as in Experimental Example 1 except that the adsorbent material AM5 was put into the front chamber instead of the adsorbent material AM1, and the adsorbent material AM6 was put into the rear chamber instead of the adsorbent material AM1.

### Experimental Example 10

A canister C10 was obtained in the same manner as in Experimental Example 1 except that the adsorbent material AM6 was put into the rear chamber instead of the adsorbent material AM1.

### [Measurement of Properties]

### (Measurement of Nitrogen Adsorption Amount)

Nitrogen adsorption isotherms of the carbon porous bodies (activated carbon) used in the carbon porous bodies PC1 to PC5 and the adsorbent material AM6 were measured at a temperature of 77 K. Specifically, first, each carbon porous body was set on a nitrogen adsorption amount-measuring apparatus (Quadrasorb SI manufactured by Quantachrome Instruments). Then, nitrogen gas was adsorbed onto each carbon porous body at a temperature of −196° C. while the pressure was varied and an adsorption amount was measured at each pressure, whereby a nitrogen adsorption isotherm was obtained.

In Experimental Examples 7 to 10, a nitrogen adsorption isotherm was calculated by weighing and averaging the nitrogen adsorption isotherm of the carbon porous body obtained by the measurement described above according to the mass ratio of the carbon porous bodies used in each Experimental Example.

The results are shown in Table 2.

### (Measurement of BET Specific Surface Area)

BET plots were calculated using a BET formula in a relative pressure range of 0.05 to 0.35 in the nitrogen adsorption isotherm obtained in the experiment described above, and a specific surface area of each Experimental Example was obtained utilizing the BET plots. A BET multi-point method was used for the calculation of the BET plots.

The results are shown in Table 2.

TABLE 2

| | Nitrogen adsorption amount | | | | | | | | | | BET |
|---|---|---|---|---|---|---|---|---|---|---|---|
| | (cm³(STP)/g) | | | | | | | | | | specific |
| | A3 | A4 | A2 | A1 | Difference in nitrogen adsorption amount | | | | | | surface |
| | (P/P₀ = | (P/P₀ = | (P/P₀ = | (P/P₀ = | (cm³(STP)/g) | | | | | | area |
| | 0.99) | 0.90) | 0.85) | 0.5) | Δ A3-A4 | Δ A3-A2 | Δ A3-A1 | Δ A4-A2 | Δ A4-A1 | Δ A | (m²/g) |
| Example 1 | 1838 | 1250 | 998 | 395 | 588 | 840 | 1443 | 252 | 855 | 603 | 1002 |
| Example 2 | 1786 | 866 | 651 | 325 | 920 | 1135 | 1461 | 215 | 541 | 326 | 823 |
| Example 3 | 1669 | 1173 | 925 | 390 | 496 | 744 | 1279 | 248 | 783 | 535 | 989 |
| Example 4 | 1333 | 811 | 544 | 282 | 523 | 789 | 1051 | 267 | 529 | 262 | 747 |
| Example 5 | 1385 | 1220 | 1150 | 465 | 165 | 235 | 920 | 70 | 755 | 685 | 1110 |
| Example 6 | 860 | 850 | 836 | 687 | 10 | 24 | 173 | 14 | 163 | 149 | 1896 |
| Example 7 | 1505 | 1114 | 943 | 494 | 391 | 563 | 1011 | 171 | 620 | 449 | 1306 |
| Example 8 | 1505 | 1114 | 943 | 494 | 391 | 563 | 1011 | 171 | 620 | 449 | 1306 |
| Example 9 | 1123 | 1035 | 993 | 576 | 88 | 130 | 547 | 42 | 459 | 417 | 1503 |
| Example 10 | 1349 | 1050 | 917 | 541 | 299 | 432 | 808 | 133 | 509 | 376 | 1449 |

In a column marked “A3 (P/P₀=0.99)” in a column marked “Nitrogen adsorption amount (cm³ (STP)/g)” in Table 2 above, nitrogen adsorption amounts A3 at a nitrogen relative pressure P/P₀ of 0.99 on the nitrogen adsorption isotherm measured at a temperature of 77 K, obtained in the nitrogen adsorption amount measurement described above, are described. In a column marked “A4 (P/P₀=0.90),” nitrogen adsorption amounts A4 at a nitrogen relative pressure P/P₀ of 0.90 on the nitrogen adsorption isotherm measured at a temperature of 77 K, obtained in the nitrogen adsorption amount measurement described above, are described. In a column marked “A2 (P/P₀=0.85),” nitrogen adsorption amounts A2 at a nitrogen relative pressure P/P₀ of 0.85 on the nitrogen adsorption isotherm measured at a temperature of 77 K, obtained in the nitrogen adsorption amount measurement described above, are described. In a column marked “A1 (P/P₀=0.5),” nitrogen adsorption amounts A1 at a nitrogen relative pressure P/P₀ of 0.5 on the nitrogen adsorption isotherm measured at a temperature of 77 K, obtained in the nitrogen adsorption amount measurement described above, are described.

In addition, in a column marked “ΔA3−A4” in a column marked “Difference in nitrogen adsorption amount (cm³ (STP)/g)” in Table 2 above, differences in the nitrogen adsorption amount obtained by subtracting a nitrogen adsorption amount A4 at a nitrogen relative pressure P/P₀ of 0.90 from a nitrogen adsorption amount A3 at a nitrogen relative pressure P/P₀ of 0.99 on the nitrogen adsorption isotherm measured at a temperature of 77 K are described. In a column marked “ΔA3−A2,” differences in the nitrogen adsorption amount obtained by subtracting a nitrogen adsorption amount A2 at a nitrogen relative pressure P/P₀ of 0.85 from a nitrogen adsorption amount A3 at a nitrogen relative pressure P/P₀ of 0.99 on the nitrogen adsorption isotherm measured at a temperature of 77 K are described. In a column marked “ΔA3−A1,” differences in the nitrogen adsorption amount obtained by subtracting a nitrogen adsorption amount A1 at a nitrogen relative pressure P/P₀ of 0.5 from a nitrogen adsorption amount A3 at a nitrogen relative pressure P/P₀ of 0.99 on the nitrogen adsorption isotherm measured at a temperature of 77 K are described. In a column marked “ΔA4−A2,” differences in the nitrogen adsorption amount obtained by subtracting a nitrogen adsorption amount A2 at a nitrogen relative pressure P/P₀ of 0.85 from a nitrogen adsorption amount A4 at a nitrogen relative pressure P/P₀ of 0.90 on the nitrogen adsorption isotherm measured at a temperature of 77 K are described. In a column marked “ΔA4−A1,” differences in the nitrogen adsorption amount obtained by subtracting a nitrogen adsorption amount A1 at a nitrogen relative pressure P/P₀ of 0.5 from a nitrogen adsorption amount A4 at a nitrogen relative pressure P/P₀ of 0.90 on the nitrogen adsorption isotherm measured at a temperature of 77 K are described. In a column marked “ΔA,” differences in the nitrogen adsorption amount obtained by subtracting a nitrogen adsorption amount A1 at a nitrogen relative pressure P/P₀ of 0.5 from a nitrogen adsorption amount A2 at a nitrogen relative pressure P/P₀ of 0.85 on the nitrogen adsorption isotherm measured at a temperature of 77 K are described.

Furthermore, in a column marked “BET specific surface area (²/g)” in Table 2 above, BET specific surface areas, obtained by the BET specific surface area measurement described above, are described.

As shown in Table 2, the nitrogen adsorption amounts A3 of the carbon porous bodies PC1 to PC3, which were obtained by the heat-treatment in the presence of the coconut shell activated carbon, were larger than the nitrogen adsorption amounts A3 of the carbon porous bodies PC4 and PC5, which were not subjected to the heat-treatment in the presence of the coconut shell activated carbon, and the carbon porous body contained in the adsorbent material AM6.

### (Measurement of Pentane Desorption Ratio)

Pentane desorption ratios of the carbon porous bodies PC1 to PC5, and the carbon porous body (activated carbon) used in the adsorbent material AM6 were measured.

Specifically, first, 3 g of each carbon porous body was weighed, and it was put into a glass column. Then, each column was attached to a gas adsorption apparatus. A mass of the carbon porous body at that time was defined as an amount A of the carbon porous body.

Then, pentane was bubbled with nitrogen gas having a temperature of 25±1° C. to generate a mixed gas of the nitrogen gas and the pentane gas. The resulting mixed gas was passed through each column to adsorb pentane onto the carbon porous body. When the adsorption treatment was performed, the temperature of the mixed gas was adjusted to 25° C., and pentane was contained in the mixed gas at a saturated concentration.

Then, each column was taken out from the gas adsorption apparatus after a certain period of time elapsed, and a mass of the column was measured. After that, the column was attached again to the gas adsorption apparatus. A case where the mass of the column at a certain point of time was the same as the mass of the column measured just before the certain point of time was determined to be a saturated adsorption state, and a mass of the carbon porous body was calculated from the mass of the column at that time, which was defined as a mass B after adsorption.

Then, nitrogen gas having a temperature of 25° C. was passed through each column to desorb pentane from the carbon porous body.

Then, a mass of the column was measured when an amount of the nitrogen gas flowing reached 150 times the volume of the carbon porous body, and a mass of the carbon porous body was calculated from the obtained mass of the column. In this way, a mass C after desorption was obtained when a bed volume was 150.

Then, a mass of the column was measured when an amount of the nitrogen gas flowing reached 300 times the volume of the carbon porous body, and a mass of the carbon porous body was calculated from the obtained mass of the column. In this way, a mass D after desorption was obtained when a bed volume was 300.

Here, a value obtained by subtracting the amount A of the carbon porous body from the mass B after adsorption was defined as an adsorption amount (B−A) per column. In addition, a value obtained by dividing the adsorption amount per column by the mass of the carbon porous body was defined as a pentane adsorption amount (g/g) per unit mass of the carbon porous body.

A value obtained by subtracting the mass C after desorption from the mass B after adsorption was defined as a desorption amount (B−C) per column at a bed volume of 150. Then, a value obtained by dividing the desorption amount (B−C) per column by the adsorption amount (B−A) per column was defined as a pentane desorption ratio [(B−C)/(B−A)×100] (%) at a bed volume of 150.

Similarly, a value obtained by subtracting the mass D after desorption at a bed volume of 300 from the mass B after adsorption was defined as a desorption amount (B−D) per column. Then, a value obtained by dividing the desorption amount (B−D) per column by the adsorption amount (B−A) per column was defined as a pentane desorption ratio [(B−D)/(B−A)×100] (%) at a bed volume of 300.

In Experimental Examples 7 to 10, a pentane adsorption amount per unit mass of the carbon porous body was calculated by weighing and averaging the pentane adsorption amount per unit mass of the carbon porous body, obtained in the measurement described above, according to the mass ratios of the carbon porous bodies in the Experimental Example.

In Experimental Examples 7 to 10, the pentane desorption ratio at a bed volume of 150 and the pentane desorption ratio at a bed volume of 300 were also calculated by weighing and averaging in the same manner as in the pentane adsorption amount.

The results are shown in Table 3.

TABLE 3

| | | | Pentane | | |
|---|---|---|---|---|---|
| | | | adsorption | Pentane | |
| | Canister | | amount | desorption ratio (%) | |
| | Front chamber | Rear chamber | (g/g) | 150 B.V. | 300 B.V. |
| Example 1 | Adsorbent material A1: 50% by mass | Adsorbent material A1: 50% by mass | 0.82 | 91 | 94 |
| Example 2 | Adsorbent material A2: 50% by mass | Adsorbent material A2: 50% by mass | 0.43 | 75 | 90 |
| Example 3 | Adsorbent material A3: 50% by mass | Adsorbent material A3: 50% by mass | 0.53 | 64 | 72 |
| Example 4 | Adsorbent material A4: 50% by mass | Adsorbent material A4: 50% by mass | 0.40 | 46 | 58 |
| Example 5 | Adsorbent material A5: 50% by mass | Adsorbent material A5: 50% by mass | 0.63 | 48 | 78 |
| Example 6 | Adsorbent material A6: 50% by mass | Adsorbent material A6: 50% by mass | 0.45 | 13 | 19 |
| Example 7 | Adsorbent material A1: 50% by mass | Adsorbent material A1: 16% by mass | 0.69 | 64 | 68 |
| | | Adsorbent material A6: 34% by mass | | | |
| Example 8 | Adsorbent material A1: 33% by mass | Adsorbent material A1: 33% by mass | 0.69 | 64 | 68 |
| | Adsorbent material A6: 17% by mass | Adsorbent material A6: 17% by mass | | | |
| Example 9 | Adsorbent material A5: 50% by mass | Adsorbent material A6: 50% by mass | 0.54 | 30 | 49 |
| Example 10 | Adsorbent material A1: 50% by mass | Adsorbent material A6: 50% by mass | 0.63 | 52 | 56 |

In a column marked “Front chamber” in a column marked “Canister” in Table 3 above, kinds of the adsorbent materials contained in the front chamber, and ratios of the amount of the corresponding adsorbent material to the total amount of the adsorbent material are described. In a column marked “Rear chamber,” kinds of the adsorbent materials contained in the rear chamber, and ratios of the amount of the corresponding adsorbent material to the total amount of the adsorbent material are described.

In addition, in a column marked “Pentane adsorption amount (g/g)” in Table 3 above, pentane adsorption amounts per unit mass of the carbon porous bodies obtained in the pentane desorption tests described above are described.

Furthermore, in a column marked “150 B.V.” in a column marked “Pentane desorption ratio (%)” in Table 3 above, pentane desorption ratios at a bed volume of 150, obtained in the pentane desorption test described above, are described. In a column marked 300 B.V.,” pentane desorption ratios at a bed volume of 300, obtained in the pentane desorption test described above, are described.

FIG. 8 is a graph showing one example of the relationship between the nitrogen adsorption amount A3 at a nitrogen relative pressure P/P₀ of 0.99 and the pentane desorption ratio on the nitrogen adsorption isotherm measured at a temperature of 77 K. FIG. 8 is made utilizing data obtained in Experimental Examples 1 to 10. In the graph shown in FIG. 8, the horizontal axis shows the nitrogen adsorption amount A3 of all of the carbon porous bodies PC1 to PC5, carbon porous bodies used in the adsorbent material AM6, and carbon porous bodies contained in the canisters C7 to C10. The vertical axis shows the pentane desorption ratio at a bed volume of 150 of all of the carbon porous bodies PC1 to PC5, the carbon porous bodies used in the adsorbent material AM6, and the carbon porous bodies contained in the canisters C7 to C10.

As shown in FIG. 8, the canisters using the carbon porous bodies having a large nitrogen adsorption amount A3 at a nitrogen relative pressure P/P₀ of 0.99 for the adsorbent material tend to have a high pentane desorption ratio.

What is claimed is:

1. A carbon porous body which has a micropore volume, calculated from an αₛ plot analysis of a nitrogen adsorption isotherm at a temperature of 77 K, of 0.1 cm³/g or less, the micropore volume being smaller than a mesopore volume calculated by subtracting the micropore volume from a nitrogen adsorption amount at a nitrogen relative pressure P/P₀ of 0.97 on the nitrogen adsorption isotherm, wherein a nitrogen adsorption amount at a nitrogen relative pressure P/P₀ of 0.5 on the nitrogen adsorption isotherm is within a range of 500 cm³ (STP)/g or less, and a nitrogen adsorption amount at a nitrogen relative pressure P/P₀ of 0.85 on the nitrogen adsorption isotherm is within a range of 600 cm³ (STP)/g or more and 1100 cm³ (STP)/g or less.

2. The carbon porous body according to claim 1, wherein a value, obtained by subtracting the nitrogen adsorption amount at a nitrogen relative pressure P/P₀ of 0.5 from the nitrogen adsorption amount at a nitrogen relative pressure P/P₀ of 0.85, is 200 cm³ (STP)/g or more.

3. The carbon porous body according to claim 1, wherein a nitrogen adsorption amount at a nitrogen relative pressure P/P₀ of 0.99 on the nitrogen adsorption isotherm at a temperature of 77 K is 1500 cm³ (STP)/g or more.

4. The carbon porous body according to claim 1, wherein a BET specific surface area obtained using nitrogen adsorption is 700 m²/g or more.

5. The carbon porous body according to claim 1, wherein a BET specific surface area obtained using nitrogen adsorption is 1200 m²/g or less.

6. A method of producing a carbon porous body, comprising:
heating an alkaline earth metal salt of benzene dicarboxylic acid at 550 to 700° C. in an inert atmosphere in the presence of a trapping material that adsorbs hydrocarbon gas to form a composite of carbon and an alkaline earth metal carbonate; and
washing the composite with washing liquid capable of dissolving the carbonate to remove the carbonate, thereby obtaining a carbon porous body.

7. The method of producing a carbon porous body according to claim 6, wherein the trapping material is at least one selected from the group consisting of activated carbon, silica gel, zeolite, and diatom earth.

8. The method of producing a carbon porous body according to claim 6, wherein the trapping material exists in at least one state of a state in which the trapping material is mixed with the alkaline earth metal salt of the benzene dicarboxylic acid and a state in which the trapping material is in a form of a filter disposed above the benzene dicarboxylic acid.

9. The method of producing a carbon porous body according to claim 6, wherein the alkaline earth metal salt of the benzene dicarboxylic acid has a molar ratio of benzene dicarboxylic acid to an alkaline earth metal within a range of 1.5:1 to 1:1.5.

10. The method of producing a carbon porous body according to claim 6, wherein the alkaline earth metal salt of the benzene dicarboxylic acid is a calcium salt of terephthalic acid.

11. An ammonia adsorbent comprising the carbon porous body according to claim 1.

12. The ammonia adsorbent according to claim 11, wherein a value, obtained by subtracting an ammonia adsorption amount at an ammonia pressure of 300 kPa from an ammonia adsorption amount at an ammonia pressure of 390 kPa, is 0.40 g/g or more.

13. A canister comprising:
a container; and
a carbon porous body housed in the container,
wherein the carbon porous body has a nitrogen adsorption amount at a nitrogen relative pressure P/P₀ of 0.99 on a nitrogen adsorption isotherm at a temperature of 77 K of 1500 cm³ (STP)/g or more.

14. A method of producing a canister, comprising:
heating an alkaline earth metal salt of benzene dicarboxylic acid at a temperature within a range of 550° C. to 700° C. in an inert atmosphere in the presence of a trapping material that adsorbs hydrocarbon gas to form a composite of carbon and an alkaline earth metal carbonate; and
washing the composite with washing liquid capable of dissolving the carbonate to remove the carbonate from the composite, thereby obtaining a carbon porous body.
